(19) United States
(12) Patent Application Publication
(10) Pub. No.: US 2024/0265763 A1
(43) Pub. Date: Aug. 8, 2024

(54) CONTROL METHOD FOR COIN HANDLING APPARATUS AND COIN HANDLING APPARATUS

(71) Applicant: GLORY LTD., Hyogo (JP)

(72) Inventor: Takuro HAMADA, Hyogo (JP)

(21) Appl. No.: 18/430,723

(22) Filed: Feb. 2, 2024

(30) Foreign Application Priority Data
Feb. 6, 2023 (JP) 2023-016020

(51) Int. Cl. G07D 1/06; G07D 9/00

(52) U.S. Cl. CPC G07D 1/06; G07D 9/00; G07D 2201/00

(57) ABSTRACT

A method according to the present disclosure is a method for the coin handling apparatus according to the present disclosure includes: performing a preparatory operation including: recognizing by a recognition unit a denomination of a coin fed from a first storage unit that stores one or more coins, and storing, in a second storage unit, a certain number of coins for each denomination of a first combination from among the one or more coins based on the denomination recognized; and dispensing at least a part of the certain number of coins stored in the second storage unit to an outlet in response to a dispensing instruction, in which a predetermined condition is satisfied, a certain number of coins for each denomination of a combination different from the first combination are stored in the second storage unit.

### CROSS REFERENCE TO RELATED APPLICATIONS

This application is entitled and claims the benefit of Japanese Patent Application No. 2023-016020, filed on Feb. 6, 2023, the disclosure of which including the specification, drawings and abstract is incorporated herein by reference in its entirety.

### TECHNICAL FIELD

The present disclosure relates to a control method for controlling a coin handling apparatus for storing and dispensing coins, and the coin handling apparatus.

### BACKGROUND ART

Conventionally, a coin handling apparatus for storing and dispensing coins is known. Such a coin handling apparatus has an area for storing mixed denominations of money and storing a change fund, and stores set denominations of coins and the change fund including the required set numbers of money for the respective denominations.

### SUMMARY

A control method for the coin handling apparatus according to the present disclosure comprises: performing a preparatory operation comprising: recognizing by a recognition unit a denomination of a coin fed from a first storage unit that stores one or more coins, and storing, in a second storage unit, a certain number of coins for each denomination of a first combination from among the one or more coins based on the denomination recognized; and dispensing at least a part of the certain number of coins stored in the second storage unit to an outlet in response to a dispensing instruction, in which when a predetermined condition is satisfied, a certain number of coins for each denomination of a combination different from the first combination are stored in the second storage unit.

### BRIEF DESCRIPTION OF DRAWINGS

FIG. 1 illustrates a basic configuration of a coin handling apparatus according to Embodiment 1;

FIG. 2 is a block diagram illustrating a functional configuration of the coin handling apparatus;

FIG. 3A illustrates a basic operation of the coin handling apparatus;

FIG. 3B illustrates a basic operation of the coin handling apparatus;

FIG. 3C illustrates a basic operation of the coin handling apparatus;

FIG. 3D illustrates a basic operation of the coin handling apparatus;

FIG. 4 illustrates a combination between the minimum required denominations and numbers of coins as a change fund in the case where the currency is euro;

FIG. 5 is a flowchart illustrating a dispensing preparatory operation performed by the coin handling apparatus according to Embodiment 1;

FIG. 6 is a flowchart illustrating a deposit operation performed by the coin handling apparatus according to Embodiment 2;

FIG. 7 is a flowchart illustrating a dispensing preparatory operation performed by the coin handling apparatus according to Embodiment 3;

FIG. 8 is a flowchart illustrating a dispensing operation performed by the coin handling apparatus according to Embodiment 3;

FIG. 9 is a flowchart illustrating a deposit operation performed by the coin handling apparatus according to Embodiment 4;

FIG. 10 is a flowchart illustrating a dispensing operation performed by the coin handling apparatus according to Embodiment 4; and

FIG. 11 is a flowchart illustrating a dispensing preparatory operation performed by the coin handling apparatus according to Embodiment 5.

### DESCRIPTION OF EMBODIMENTS

In the conventional coin handling apparatus, storing a fund of coins of a combination different from a preset combination between denominations and numbers of coins required for the respective denominations is not considered.

The present disclosure aims to provide a control method for a coin handling apparatus and the coin handling apparatus that make it possible to store coins of a combination between a denomination and a number of coins required for each denomination, the combination being different from a set combination between a denomination and a number of coins for each denomination, thereby making it possible to reduce extension of a dispensing time while achieving miniaturization by using mixed storage.

The control method for the coin handling apparatus according to the present disclosure comprises: performing a preparatory operation comprising: recognizing by a recognition unit a denomination of a coin fed from a first storage unit that stores one or more coins, and storing, in a second storage unit, a certain number of coins for each denomination of a first combination from among the one or more coins based on the denomination recognized; and dispensing at least a part of the certain number of coins stored in the second storage unit to an outlet in response to a dispensing instruction, in which when a predetermined condition is satisfied, a certain number of coins for each denomination of a combination different from the first combination are stored in the second storage unit.

The predetermined condition may be a condition relating to a time for the preparatory operation for storing the certain number of coins from the first storage unit to the second storage unit.

The predetermined condition may be a case where the time for the preparatory operation is equal to or longer than a predetermined time.

The predetermined condition may be a case where the preparatory operation is not completed when a next deposit acceptance command arrives.

A coin of a denomination which is inadequate in number for the first combination may be substitutable with a coin of a denomination whose face value is smaller than that of the denomination of the coin which is inadequate in number for the first combination.

The predetermined condition is a condition of a ratio of coins for each denomination stored in the first storage unit, and when a term of the ratio of coins of a first denomination is equal to or greater than a predetermined value, a certain number of the coins of the first denomination which make a same amount of money as a face value of a second denomination whose face value is greater than that of the first denomination may be stored instead of a coin of the second denomination in the second storage unit.

The predetermined condition is a condition of a number of coins for each denomination stored in the first storage unit, and when the number of coins of a first denomination is equal to or greater than a predetermined value, a certain number of the coins of the first denomination which make a same amount of money as a face value of the second denomination whose face value is greater than that of the first denomination are stored instead of a coin of the second denomination in the second storage unit.

The certain number of coins of the first denomination which make the same amount of money as the face value of the second denomination may be dispensed instead of the coin of the second denomination in response to the dispensing instruction.

The method further comprises storing a deposited coin in the first storage unit, in which
the predetermined condition is a condition relating to a denomination of the deposited coin, and
when the predetermined condition is satisfied, a coin of a corresponding denomination from among a plurality of the deposited coins may be stored in the second storage unit.

The predetermined condition may be that a coin of a denomination preset by a user is deposited.

The predetermined condition may be that a coin of a rare denomination is deposited.

The predetermined condition may be whether a deposited coin of a denomination is greater in number than an initial setting for the number of coins for the first storage unit. The predetermined condition may be whether a ratio of a deposited coin of a denomination is greater than an initial setting ratio for the first storage unit. A set number or a set ratio may be changeable based on a history of either a dispense ratio and a deposit ratio or a dispense number and a deposit number for each denomination.

A coin of a preset denomination may be a coin of a denomination that is not used as change.

A coin handling apparatus according to the present disclosure comprises: a first storage unit that stores a coin; a second storage unit that stores a coin to be dispensed; a transport unit that transports the coin along a transport path; a recognition unit disposed on the transport path and configured to recognize a denomination of the coin; and a control unit that controls the transport unit based on a result of recognition by the recognition unit such that a certain number of coins for each denomination of a first combination are stored in the second storage unit, the certain number of coins being from among a plurality of the coins fed from the first storage unit, in which the control unit is capable of storing, in the second storage unit, a certain number of coins for each denomination of a combination different from the first combination when a predetermined condition is satisfied.

The predetermined condition is a case where a time for a preparatory operation in which the coin to be dispensed is stored in the second storage unit is equal to or greater than a predetermined value, and when the predetermined condition is satisfied, a coin of a denomination whose face value is smaller than a face value of a coin of a denomination which is inadequate in number for the first combination is storable in the second storage unit instead of the coin which is inadequate in number for the first combination.

According to the present disclosure, it is possible to reduce extension of a dispensing time while achieving miniaturization of the coin handling apparatus by using mixed storage.

Hereinafter, with reference to the accompanying drawings, embodiments of a control method for a coin handling apparatus and the coin handling apparatus of the present disclosure will be described.

### Embodiment 1

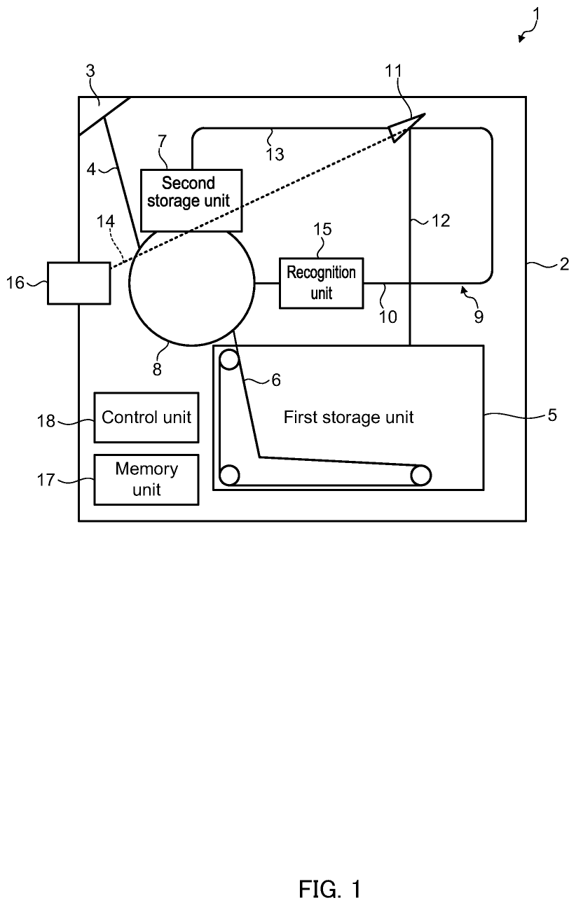

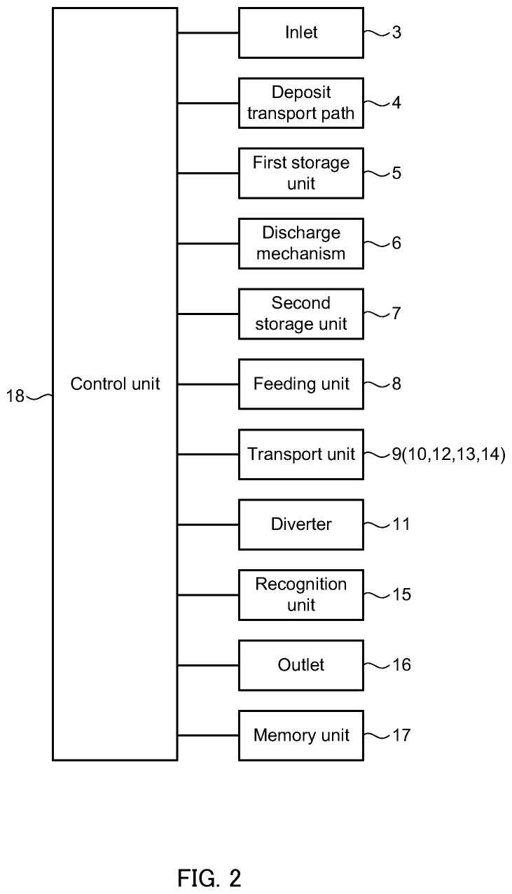

Embodiment 1 will be described with reference to the accompanying drawings. FIG. 1 illustrates a basic configuration of a coin handling apparatus according to Embodiment 1, and FIG. 2 is a block diagram illustrating a functional configuration of the coin handling apparatus. In Embodiment 1, in a case where a predetermined condition is satisfied, coins are prepared as a dispense fund which are coins of a combination between denominations and numbers of coins for the respective denominations and which are different from coins of a combination between set denominations and set numbers of coins required respectively for the set denominations.

The coin handling apparatus 1 performs a coin storing process and a coin dispensing process. The coin handling apparatus 1 comprises a housing 2, an inlet 3, a deposit transport path 4, a first storage unit 5, a discharge mechanism 6, a second storage unit 7, a feeding unit 8, a transport unit 9, a common transport path 10, a diverter 11, a first transport path 12, a second transport path 13, a dispensing transport path 14, a recognition unit 15, an outlet 16, a memory unit 17, and a control unit 18.

The housing 2 houses components of the coin handling apparatus 1.

The inlet 3 is an opening portion for receiving a deposit from the outside of the coin handling apparatus 1. Coins deposited from the inlet 3 are moved to the feeding unit 8 via the deposit transport path 4.

The deposit transport path 4 transports the deposited coins to the feeding unit 8.

The first storage unit 5 stores coins of a plurality of denominations in a mixed manner. In addition, the first storage unit 5 is capable of discharging the stored coins. The coins are discharged from the first storage unit 5 to the feeding unit 8.

The discharge mechanism 6 is a mechanism for discharging coins from the first storage unit 5 to the feeding unit 8. The discharge mechanism 6 is, for example, a belt conveyor disposed inside the first storage unit 5.

The second storage unit 7 stores coins of a plurality of denominations in a mixed manner. In addition, the second storage unit 7 is capable of discharging the stored coins. The coins are discharged from the second storage unit 7 to the feeding unit 8.

The second storage unit 7 stores therein coins which are part of a plurality of coins stored in the first storage unit 5 and which are discharged from the first storage unit 5. The coins stored in the second storage unit 7 are used as a dispense fund, for example.

The feeding unit 8 retains coins and sequentially feeds the retained coins one by one to the transport unit 9.

Further, the feeding unit 8 comprises, for example, a disk having a projection on a surface thereof. The disk is disposed to be inclined at a predetermined angle with respect to the vertical direction, and is rotated by a motor or the like while being inclined. When coins enter the feeding unit 8, the coins are retained at a lower portion of the disk. The coins are moved upward by being hooked one by one with the rotation of the disk. The coins hooked on the projection and moved upward are fed through a hole portion formed in an outer peripheral portion of the feeding unit 8 outside of the disk. The hole portion is connected to the common transport path 10 forming the transport unit 9. With such a configuration, the feeding unit 8 is capable of feeding coins one by one to the common transport path 10.

Further, the disk of the feeding unit 8 is disposed below a discharge port of the second storage unit 7 and close to the second storage unit 7. Further, the second storage unit 7 includes an openable and closable bottom portion. When the bottom portion is opened, the coins stored in the second storage unit 7 drop into the inside of the feeding unit 8 disposed immediately below the second storage unit 7. With such a configuration, the coins discharged from the second storage unit 7 are immediately put in the feeding unit 8. It is thus possible to shorten the path through which the coins are transported, so as to perform quick feeding from the second storage unit 7 to the transport unit 9.

The transport unit 9 transports the coins along the common transport path 10, the first transport path 12 that transports the coins fed from the feeding unit 8 to the first storage unit 5, and the second transport path 13 that transports the coins fed from the feeding unit 8 to the second storage unit 7, which will be described below. The transport unit 9 transports the coins using, for example, a belt or a chute that is a path for dropping coins. The transport unit 9 transports the coins along the transport path, for example, by driving a pulley and a belt by a drive source such as a motor.

The common transport path 10 is a transport path that connects the feeding unit 8 and the diverter 11. The recognition unit 15 is disposed on the common transport path 10. By the diverter 11, the coins on the transport path are diverted and transported from the common transport path 10 to the first transport path 12, the second transport path 13, and the dispensing transport path 14.

The first transport path 12 is a transport path that connects between the diverter 11 and the first storage unit 5. The second transport path 13 is a transport path that connects between the diverter 11 and the second storage unit 7. The dispensing transport path 14 is a transport path that connects between the diverter 11 and the outlet 16. As described above, the transport unit 9 is comprised of transport paths including the common transport path 10, the first transport path 12, the second transport path 13, and the dispensing transport path 14.

The recognition unit 15 is an apparatus for recognizing the denomination, authenticity, and fitness of each coin transported by the transport unit 9. The recognition unit 15 may have a function of counting the number of coins transported by the transport unit 9. The recognition unit 15 includes a sensor such as, e.g., a magnetic sensor, an optical sensor, or an imaging sensor, and recognizes a passing coin.

The outlet 16 is an opening portion for dispensing coins to the outside of the coin handling apparatus 1.

The memory unit 17 is a memory that records various kinds of information necessary for various operations of the coin handling apparatus 1. Examples of the information recorded in the memory unit 17 include: first denomination and number information indicating the numbers of coins for respective denominations of the coins stored in the first storage unit 5 at that time; second denomination and number information indicating the numbers of coins for respective denominations of the coins stored in the second storage unit 7; and the like.

As illustrated in FIG. 2, the control unit 18 controls the operations of the inlet 3, the deposit transport path 4, the first storage unit 5, the discharge mechanism 6, the second storage unit 7, the feeding unit 8, the transport unit 9, the common transport path 10, the diverter 11, the first transport path 12, the second transport path 13, the dispensing transport path 14, the recognition unit 15, the outlet 16, and the memory unit 17 described above. The control unit 18 is (includes), for example, a CPU. For example, a program corresponding to the control unit 18 is stored in advance in a dedicated storage apparatus, and the program is executed by hardware such as the

CPU. The control unit 18 thus operates. The functions and operations of the coin handling apparatus 1 in the descriptions of the present embodiment are achieved by operation of the control unit 18. The processing described as being performed by the coin handling apparatus 1 in the present embodiment is achieved by the control unit 18. The control unit 18 may be mounted on one or more electrical circuits or processing circuits including one or more general-purpose processors, application-specific processors, integrated circuits, Application Specific Integrated Circuits (ASICs), conventional circuits, and/or combinations thereof programmed to be capable of performing each process.

### Basic Operation of Coin Handling Apparatus

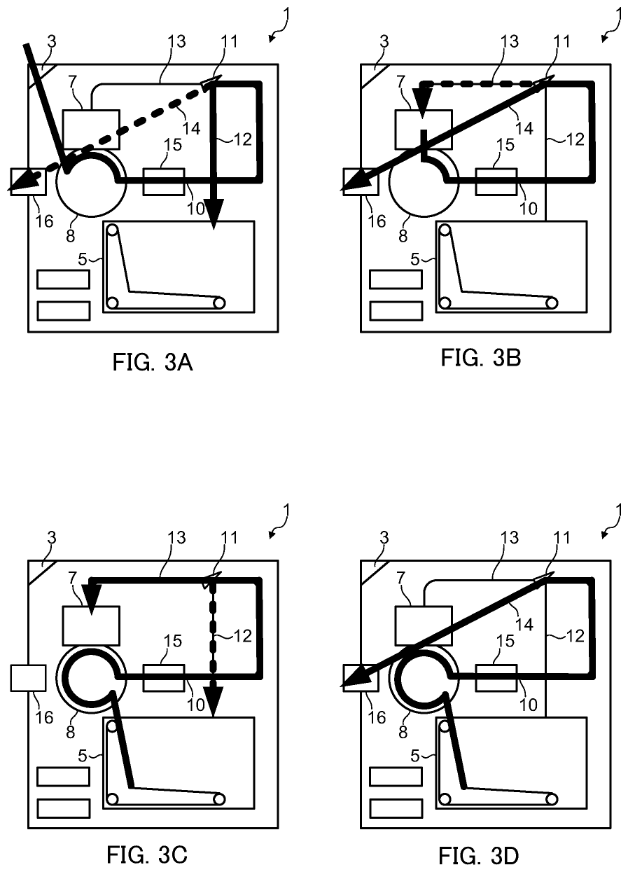

Next, the basic operation of the coin handling apparatus 1 according to Embodiment 1 will be described. FIG. 3 is a diagram for explaining the basic operation of the coin handling apparatus 1. In FIGS. 3A to 3D, solid arrows indicate movement of coins in the operations.

### Deposit Operation

FIG. 3A is a diagram for explaining a deposit operation in which coins are deposited from the outside of the coin handling apparatus 1. As illustrated in FIG. 3A, the coins deposited from the inlet 3 are first put in the feeding unit 8. The feeding unit 8 feeds the deposited coins one by one to the common transport path 10. The coins fed are recognized by the recognition unit 15 on the common transport path 10.

The recognized coins are transported to the first storage unit 5 via the common transport path 10 and the first transport path 12, and are stored in the first storage unit 5.

Incidentally, for example, when the first storage unit 5 cannot store a new coin because the first storage unit 5 is full, or when a result of the recognition reveals that the new coin is a coin which should not be stored in the first storage unit 5, the recognized coin is transported to the outlet 16 via the dispensing transport path 14 and is returned as illustrated by the dashed arrow in FIG. 3A.

### Dispensing Operation

Next, FIG. 3B is a diagram for explaining a dispensing operation of dispensing coins from the second storage unit 7 in the coin handling apparatus 1. As described above, coins to be dispensed to the outside of the coin handling apparatus 1, such as a change fund, are stored in the second storage unit 7, and the coin handling apparatus 1 dispenses a requested amount of coins from the second storage unit 7 in response to a dispensing instruction. This dispensing operation is performed, for example, when the coin handling apparatus 1 is requested to dispense change from the outside.

As illustrated in FIG. 3B, all the coins stored in the second storage unit 7 are first discharged from the second storage unit 7. The coins discharged from the second storage unit 7 are put in the feeding unit 8 disposed immediately below. The feeding unit 8 feeds the disposed coins one by one to the common transport path 10. The coins fed are recognized by the recognition unit 15 on the common transport path 10.

The control unit 18 determines whether or not to dispense the coins recognized one by one, and when the coin is determined to be dispensed, the coin is transported to the outlet 16 via the common transport path 10 and the dispensing transport path 14, and is dispensed. Further, when determining not to dispense the recognized coin, the control unit 18 returns the coin to the second storage unit 7 via the common transport path 10 and the second transport path 13 as indicated by the dashed arrow in FIG. 3B.

The determination method for determining whether or not to dispense the recognized coin is not particularly limited in the present disclosure, but for example, the control unit 18 dispenses the newly recognized coin when the amount of money calculated by adding the amount of money of the newly recognized coin to the total amount of money of the coins that have been dispensed so far does not exceed the amount of money requested to be dispensed, for example, the change amount.

In the above description, all the coins are discharged from the second storage unit 7 in the dispensing operation, but the present disclosure is not limited thereto. For example, in the dispensing operation, a predetermined number of coins may be discharged from the second storage unit 7. Then, when the total amount of money of coins discharged from the second storage unit 7 is less than the requested amount of money, coins for the outstanding amount of money may be discharged from the first storage unit 5.

### Dispensing Preparatory Operation

Next, FIG. 3C is a diagram for explaining a dispensing preparatory operation for replenishing the second storage unit 7 with coins from the first storage unit 5. The dispensing preparatory operation is an operation for preparing (supplying), for next dispensing, the coins dispensed from the second storage unit 7 by the above-described dispensing operation. However, the dispensing preparatory operation in the coin handling apparatus 1 of the present disclosure does not necessarily supply the coins of the same denomination as the coins dispensed from the second storage unit 7.

As illustrated in FIG. 3C, coins are first discharged from the first storage unit 5. At this time, the first storage unit 5 randomly discharges the coins from among stored coins. That is, it is assumed that the denominations and numbers of coins for the respective denominations of the coins discharged by the first storage unit 5 are not uniform.

The coins discharged from the first storage unit 5 are put in the feeding unit 8. The feeding unit 8 feeds the deposited coins one by one to the common transport path 10. The coins fed are recognized by the recognition unit 15 on the common transport path 10.

The control unit 18 determines whether or not to store, in the second storage unit 7, the coins recognized one by one, and when the coin is determined to be stored, the coin is transported to the second storage unit 7 via the common transport path 10 and the second transport path 13 and is stored in the second storage unit 7. Further, when determining not to store the recognized coin in the second storage unit 7, the control unit 18 returns the coin to the first storage unit 5 via the common transport path 10 and the first transport path 12 as illustrated by the dashed arrow in FIG. 3C. The determinations of the control unit 18 at the time of the dispensing preparatory operation will be described in detail later.

The coin handling apparatus 1 is capable of repeatedly performing the dispensing operation and the dispensing preparatory operation, so as to repeatedly perform settlement of payment or the like. The second storage unit 7 only needs to store therein at least denominations and numbers of coins that can make the possible amount of money required for a single dispensing operation.

### Collection Operation

Next, FIG. 3D is a diagram for explaining a collection operation performed by an administrator of the coin handling apparatus 1 for collecting coins stored in the first storage unit 5. The collection operation of the coin handling apparatus 1 is performed in order to collect proceeds from sales, for example, when the coin handling apparatus 1 is an automatic settlement machine.

As illustrated in FIG. 3D, coins discharged from the first storage unit 5 are put in the feeding unit 8. The feeding unit 8 feeds the input coins one by one to the common transport path 10. The coins fed are recognized by the recognition unit 15 on the common transport path 10.

The recognized coins are transported to the outlet 16 via the common transport path 10 and the dispensing transport path 14, and dispensed. The collection operation is performed, for example, until all of the coins stored in the first storage unit 5 are discharged or a predetermined number of or amount of money of coins are discharged. The collection operation may be performed, for example, until the total amount of money of coins dispensed from the first storage unit 5 reaches a predetermined amount of money, or until the number of dispensed coins dispensed from the first storage unit 5 or the number of coins of a predetermined denomination reaches a predetermined number.

Further, the collection operation may be performed until the total amount of money of the coins remaining in the first storage unit 5 reaches a predetermined amount, or until the number of coins remaining in the first storage unit 5 or the number of coins of a predetermined denomination reaches a predetermined number.

Various operations as illustrated in FIGS. 3A to 3D are achieved by the control unit 18 controlling the respective components of the coin handling apparatus 1 according to the type of operation. The first denomination and number information indicating the denominations and numbers of coins stored in the first storage unit 5 is recorded in the memory unit 17 of the coin handling apparatus 1. The first denomination and number information is updated every time a coin is newly stored in the first storage unit 5 and every time a coin is discharged. The second denomination information on the coins stored in the second storage unit 7 is recorded in the memory unit 17, and is updated every time a coin is deposited in and dispensed from the second storage unit 7.

As described above, in the coin handling apparatus 1 according to Embodiment 1, after the coins fed from the feeding unit 8 are recognized by the recognition unit 15, the coins are transported to different transport destinations depending on the type of operation and the recognition result.

### Dispensing Preparatory Operation

Next, the dispensing preparatory operation by the coin handling apparatus 1 according to Embodiment 1 will be described in detail. After the coins discharged from the second storage unit 7 by the dispensing operation are dispensed through the outlet 16, the control unit 18 starts the dispensing preparatory operation. Specifically, the control unit 18 prepares a basic dispense fund in the second storage unit 7.

In the present embodiment, a combination between the minimum required denominations and numbers of coins for the respective denominations is prepared as the basic dispense fund. The denominations of coins are those which can be dispensed as coins. The combination between the denominations and numbers of coins for the respective denominations of the basic dispense fund is, for example, a combination between the minimum required denominations and numbers of coins for respective denominations which allows dispensing of all the amounts of money smaller than the minimum amount of money of a banknote handled. The basic dispense fund is not limited to this, and may be arbitrarily set.

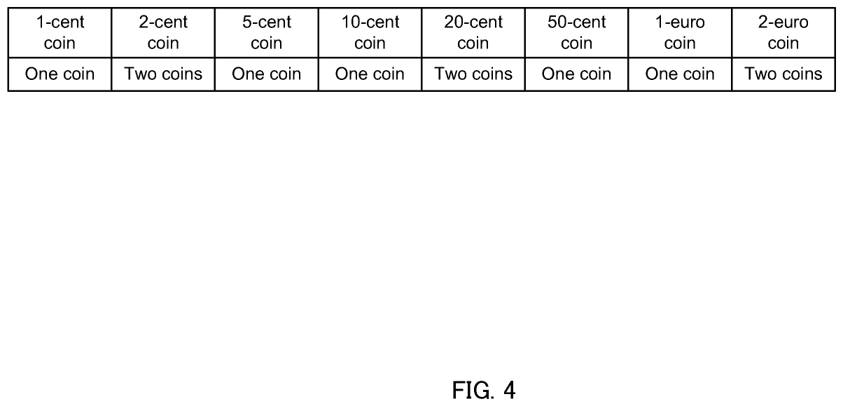

As the dispense fund which allows dispensing of all the amounts of money smaller than the minimum amount of money of the banknote handled, the combination between the minimum required denominations and numbers of coins for the respective denominations is determined in advance according to the currency. FIG. 4 illustrates the combination between the minimum required denominations and numbers of coins which allows dispensing of all the amounts of money smaller than the minimum amount of money of the banknote handled when the currency is euro. In the case of euro, the minimum required numbers of respective coins for dispensing of all the amounts of money up to 4 euros 99 cents are one 1-cent coin, two 2-cent coins, one 5-cent coins, one 10-cent coins, two 20-cent coins, one 50-cent coins, one 1-euro coin, and two 2-euro coins.

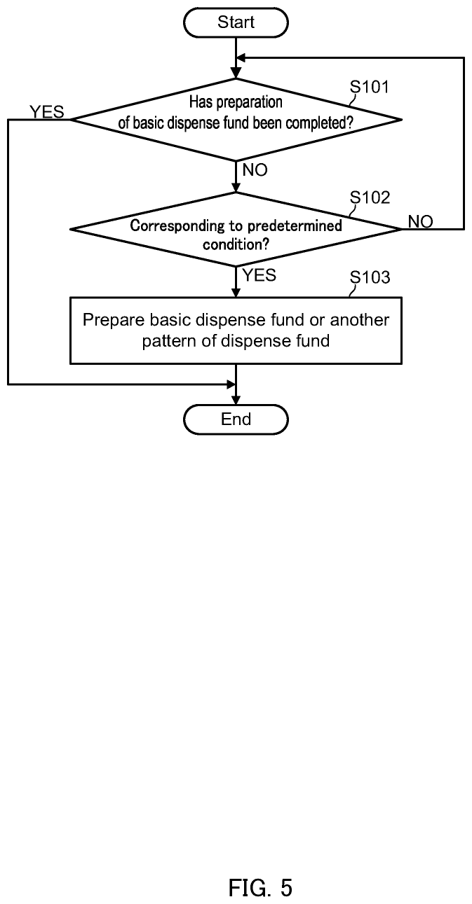

FIG. 5 is a flowchart illustrating the dispensing preparatory operation performed by the coin handling apparatus 1 according to Embodiment 1. After starting the dispensing preparatory operation, the control unit 18 determines whether or not preparation of the basic dispense fund has been completed (step S101). In a preparation method for preparing the basic dispense fund, in a case where the coins already stored in the second storage unit 7 make the basic dispense fund complete, the control unit 18 may determine at this time that the preparation has been completed. Alternatively, after coins for making up for the coins dispensed from the second storage unit 7 by the dispensing operation are all transported and stored from the first storage unit 5 to the second storage unit 7, the control unit 18 may determine that the preparation has been completed.

When it is determined that preparation of the basic change fund has been completed (“YES” in step S101), the dispensing preparatory operation ends.

When the preparation of the basic change fund has not been completed, that is, when the coins already stored in the second storage unit 7 do not make the basic dispense fund complete and not all the required coins have been obtained from the first storage unit 5 (“NO” in step S101), the control unit 18 checks whether or not a predetermined condition is satisfied (step S102).

The predetermined condition may include the following two cases. The first condition is a case where a predetermined time for the dispensing preparatory operation as set by the control unit 18 in advance has elapsed, and the second condition is a case where the next deposit acceptance command arrives. The predetermined condition may include only one of the conditions.

When it is determined that the predetermined condition is not satisfied (“NO” in step S102), the control unit 18 continues the preparatory operation for the basic dispense fund.

When it is determined that the predetermined condition is satisfied (“YES” in step S102), the control unit 18 sets a plurality of patterns of the dispense fund. In the present example, a control method is changed such that not only the basic dispense fund but also another pattern of the dispense fund is prepared (step S103).

The dispense fund of another pattern is, for example, a pattern that makes it possible to substitute a denomination (one 2-cent coin) that is inadequate in number for the basic dispense fund at that time with a denomination of a lower face value (two 1-cent coins).

In a preparation method for preparing the dispense fund of the other pattern, in a case where the coins already stored in the second storage unit 7 make the dispense fund of the other pattern complete, the control unit 18 may determine at this time that the preparation has been completed. Alternatively, the control unit 18 may determine that the preparation is completed, when coins are transported from the first storage unit 5 and the dispense fund of the other pattern is stored in the second storage unit 7. In either case, the dispensing preparatory operation ends.

Thus, according to the control method for the coin handling apparatus and the coin handling apparatus according to Embodiment 1, when the predetermined condition is satisfied, it is possible to use, as the dispense fund, coins of a combination between the denominations and numbers of coins for the respective denominations, the coins being different from coins of a set combination between the denominations and numbers of coins for the respective denominations. It is thus possible to reduce a delay in dispensing time.

### Embodiment 2

Next, Embodiment 2 of the control method for the coin handling apparatus and the coin handling apparatus of the present disclosure will be described. In Embodiment 2 described below, the same reference numerals are given to the same components as those in Embodiment 1, and the description thereof will be omitted. Embodiment 2 is different from the other embodiments in the deposit operation performed in the case where coins of rare denominations are deposited.

Embodiment 2 will be described with reference to the accompanying drawings. Since the basic configuration of the coin handling apparatus and the functional configuration of the coin handling apparatus are the same as those of Embodiment 1, the description thereof will be omitted.

### Deposit Operation

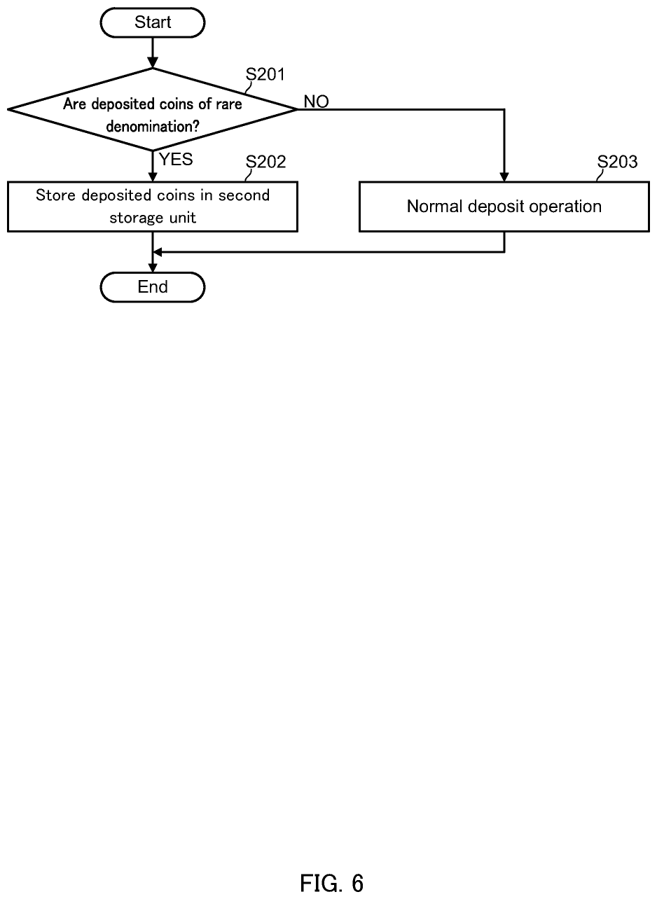

A deposit operation by the coin handling apparatus 1 according to Embodiment 2 will be described. FIG. 6 is a flowchart illustrating the deposit operation performed by the coin handling apparatus according to Embodiment 2.

When coins are deposited through the inlet 3, the coins are recognized by the recognition unit 15. The control unit 18 determines whether each of the deposited coins is of a rare denomination (step S201). The rare denomination is a small number of issued commemorative coins and the like which are highly collectible.

When it is determined that the deposited coin is of a rare denomination (“YES” in step S201), the control unit 18 transports and stores the coin to and in the second storage unit 7 (step S202), and the deposit operation ends. Specifically, the coin is transported to the second storage unit 7 via the common transport path 10 and the second transport path 13, and is stored in the second storage unit 7.

By controlling in this way, it is possible to preferentially dispense coins of rare denominations from the outlet 16, or to facilitate collection of the coins of rare denominations from the outlet 16 after business. The setting of preferentially dispensing coins or collecting coins after business can be changed at each store in which the coin handling apparatus 1 is installed.

Further, in the collection operation in this case, the coins of the rare denominations are transported from the second storage unit 7 to the outlet 16 via the common transport path 10 and the dispensing transport path 14, and are dispensed.

When it is determined that a deposited coin is not of a rare denomination (“NO” in step S201), the control unit 18 transports and stores the deposited coin to and in the first storage unit 5 by performing the normal deposit process (step S203), and the deposit operation ends.

As described above, according to the control method for the coin handling apparatus and the coin handling apparatus of Embodiment 2, when the condition that a deposited coin is of a rare denomination is satisfied, the coin of the rare denomination is stored in the second storage unit in which a small number of coins are stored. It is thus possible to easily dispense or collect the coins of rare denominations.

### Embodiment 3

Next, Embodiment 3 of the control method for the coin handling apparatus and the coin handling apparatus of the present disclosure will be described. In Embodiment 3 described below, the same reference numerals are given to the same components as those in Embodiment 1, and the description thereof will be omitted. Embodiment 3 is different from the other embodiments in the dispensing preparatory operation and the dispensing operation performed in the case where coins of a denomination greater in number than the initial setting for the number of coins are stored, among the basic operations of the coin handling apparatus.

Embodiment 3 will be described with reference to the accompanying drawings. Since the basic configuration of the coin handling apparatus and the functional configuration of the coin handling apparatus are the same as those of Embodiment 1, the description thereof will be omitted. In Embodiment 3, a banknote processing apparatus (not illustrated) that performs a banknote storing process and a banknote dispensing process is disposed closely in addition to the coin handling apparatus 1, and both coins and banknotes can be handled.

### Dispensing Preparatory Operation

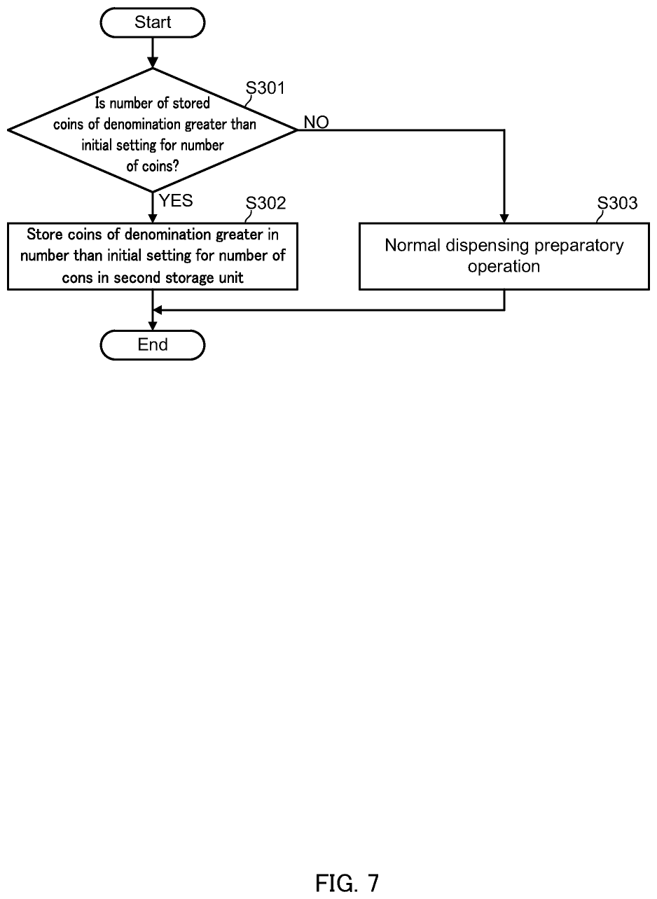

The dispensing preparatory operation by the coin handling apparatus 1 according to Embodiment 3 will be described. FIG. 7 is a flowchart illustrating the dispensing preparatory operation performed by the coin handling apparatus according to Embodiment 3.

When the number of coins of a denomination stored in the first storage unit 5 is greater than the initial setting for the number of coins, a separate collection operation is required. The control unit 18 determines whether the number of coins of the denomination stored in the first storage unit 5 is greater than the initial setting for the number of coins (step S301). This example will be described in relation to a case where the numbers of 1-euro coins and 2-euro coins are greater than the initial settings for the numbers of coins.

When it is determined that the numbers of coins of the denominations stored in the first storage unit 5 are greater than the initial settings for the numbers of coins (“YES” in step S301), the control unit 18 transports the coins of the denominations determined to be greater in number (1-euro coins and 2-euro coins) to the second storage unit 7 and stores the coins therein (step S302), and the dispensing preparatory operation ends.

When it is determined that the numbers of coins of the denominations stored in the first storage unit 5 are not greater than the initial settings for the numbers of coins (“NO” in step S301), the control unit 18 performs the normal dispensing preparatory operation (step S303), and the dispensing preparatory operation ends. Whether or not the numbers of coins are greater than the initial settings for the numbers of coins may be determined by comparison using total numbers of coins stored in the first storage unit 5 and the second storage unit 7.

### Dispensing Operation

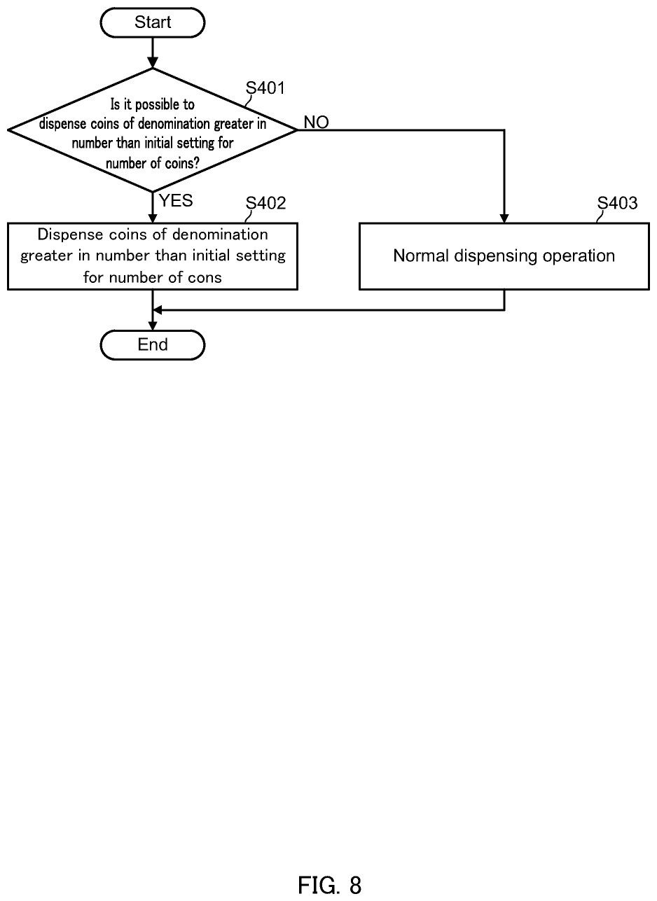

Next, the dispensing operation by the coin handling apparatus 1 according to Embodiment 3 will be described. FIG. 8 is a flowchart illustrating the dispensing operation performed by the coin handling apparatus according to Embodiment 3.

Upon receiving a dispensing instruction, the control unit 18 determines whether or not coins of a denomination stored in the first storage unit 5 and being greater in number than the initial setting for the number of coins can be dispensed (step S401). The present example will be described in relation to a case where dispensing a 5-euro banknote is requested.

When it is determined that the coins stored in the first storage unit 5 and being greater in number than the initial setting for the number of coins can be dispensed (“YES” in step S401), the control unit 18 dispenses the coins of the denomination greater in number than the initial setting for the number of coins from the second storage unit 7 (step S402), and the dispensing operation ends. The determination as to whether or not the dispensing is possible is made based on the amount of money requested by a dispensing request, the denominations of coins stored in the second storage unit 7, and the numbers of coins for the respective denominations. In the present example, when the numbers of 1-euro coins or 2-euro coins stored in the first storage unit 5 are greater than the initial setting, determination of whether, for example, one 1-euro coin and two 2-euro coins are stored in the second storage unit 7 is made in response to the dispensing request for a 5-euro banknote. When one 1-euro coin and two 2-euro coins are stored in the second storage unit 7, one 1-euro coin and two 2-euro coins are dispensed instead of the 5-euro banknote.

When it is determined that the coins of the denominations greater in number than the initial setting for the number of coins cannot be dispensed, that is, when it is determined that the coins of the denominations stored in the first storage unit 5 are not greater than the initial setting for the number of coins (“NO” in step S401), the control unit 18 performs the normal dispensing operation (step S403), and the dispensing operation ends. Incidentally, even when coins of a denomination greater in number than the initial setting for the number of coins are stored in the first storage unit 5, it is determined in step S401 that the coins of the denomination greater in number than the initial setting for the number of coins cannot be dispensed, when the dispensing amount of money in the dispensing instruction cannot be made by the coins of the corresponding denomination stored in the second storage unit 7.

In the present embodiment, higher value coins are preferentially dispensed (one 1-euro coin and two 2-euro coins are dispensed) in response to the dispensing instruction for the 5-euro banknote. However, any setting is possible in which lower value coins are preferentially dispensed (three 1-euro coins and one 2-euro coins are dispensed) or only the lower value coins are dispensed (five 1-euro coins are dispensed).

Note that Embodiment 3 is not limited to substitution of banknotes. For example, when 50-cent coins and 1-euro coins stored in the first storage unit 5 and the second storage unit 7 are greater in number than the initial settings for the numbers of coins, two 50-cent coins and one 1-euro coin instead of the 2-euro coin may be dispensed in response to the dispensing instruction for a 2-euro coin.

Further, when the number of coins of a certain denomination is greater than a predetermined set number and when a target coin is deposited, the target coin may be transported to and stored in the second storage unit 7 instead of the first storage unit 5. Determination as to whether or not the number of coins is greater than the initial setting for the number of coins may be made by comparing the number of coins stored in the first storage unit 5 and the second storage unit 7 with the initial setting for the number of coins.

As described above, according to the control method for the coin handling apparatus and the coin handling apparatus of Embodiment 3, when the condition that the coins of a certain denomination are stored in excess of the predetermined set number of coins is satisfied, a corresponding coin is stored in the second storage unit regardless of the dispense fund pattern setting. It is thus possible to facilitate the dispensing of coins of denominations that are likely to be increasing in number, so as to reduce the frequency of collection.

### Embodiment 4

Next, Embodiment 4 of the control method for the coin handling apparatus and the coin handling apparatus of the present disclosure will be described. In Embodiment 4 described below, the same reference numerals are given to the same components as those in Embodiment 1, and the description thereof will be omitted. Embodiment 4 is different from the other embodiments in the deposit operation and the dispensing operation performed when a coin of a denomination not used as change is deposited, among the basic operations of the coin handling apparatus.

Embodiment 4 will be described with reference to the accompanying drawings. Since the basic configuration of the coin handling apparatus and the functional configuration of the coin handling apparatus are the same as those of Embodiments 1 to 3, the description thereof will be omitted.

### Deposit Operation

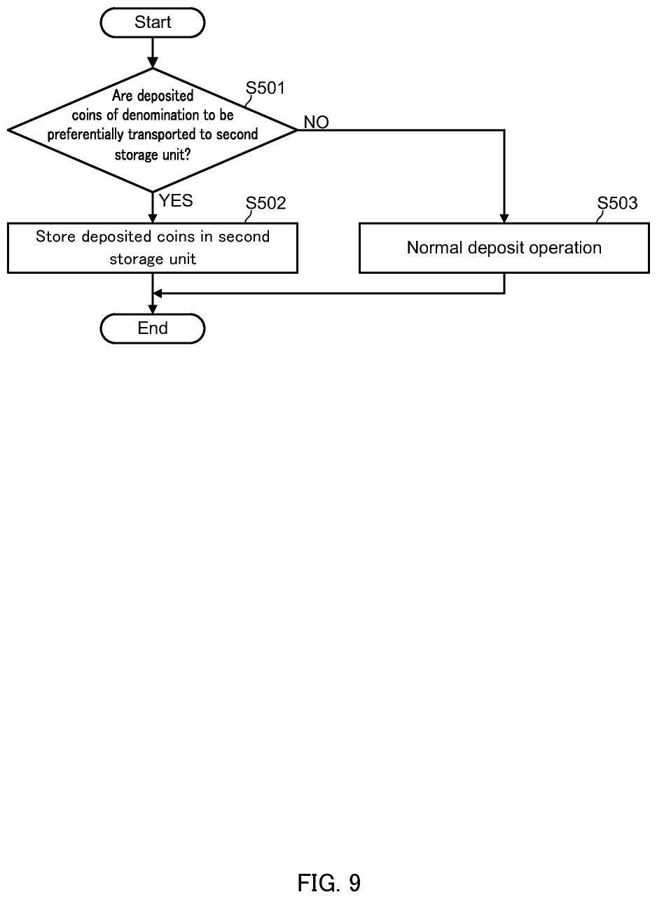

A deposit operation by the coin handling apparatus 1 according to Embodiment 4 will be described. FIG. 9 is a flowchart illustrating the deposit operation performed by the coin handling apparatus according to Embodiment 4.

When coins are deposited through the inlet 3, the coins are recognized by the recognition unit 15. The control unit 18 determines whether each of the deposited coins is of a denomination to be preferentially transported to the second storage unit 7 (step S501).

When it is determined that the deposited coin is of the denomination to be preferentially transported to the second storage unit 7 (YES″ in step S501), the control unit 18 transports and stores the coin to and in the second storage unit 7 (step S502), and the deposit operation ends. Specifically, the coin is transported to the second storage unit 7 via the common transport path 10 and the second transport path 13, and is stored in the second storage unit 7.

In the present embodiment, the denomination of coins to be preferentially transported is a denomination that is not used as change in the store, and is, for example, the 1-cent coin. When the denominations include 1-cent coin, 2-cent coin, 5-cent coin, 10-cent coin, 20-cent coin, 50-cent coin, 1-euro coin, and 2-euro coin, the coin handling apparatus 1 receives and deposits all the denominations.

On one hand, when the 1-cent coin is not used as change in the operation of the store in which the coin handling apparatus 1 is installed, such as in the case where the cheapest price setting is 2 cents, for example, a deposited 1-cent coin is transported to the second storage unit 7 so as to be easily collected later.

On the other hand, also when it is desirable to preferentially use the 1-cent coin as change upon deposit of the 1-cent coin because the 1-cent coin is not often used in the operation of the store in which the coin handling apparatus 1 is installed, such as in the case where the cheapest price setting is 2 cents, for example, the 1-cent coin is transported to the second storage unit 7.

When it is determined that the deposited coin is not of the denomination that is not used as change (“NO” in step S501), the control unit 18 performs the normal deposit process (step S503), and the deposit operation ends.

### Dispensing Preparatory Operation

The dispensing preparatory operation by the coin handling apparatus 1 according to Embodiment 4 is the same as the dispensing preparatory operation by the coin handling apparatus 1 according to Embodiment 1.

### Dispensing Operation

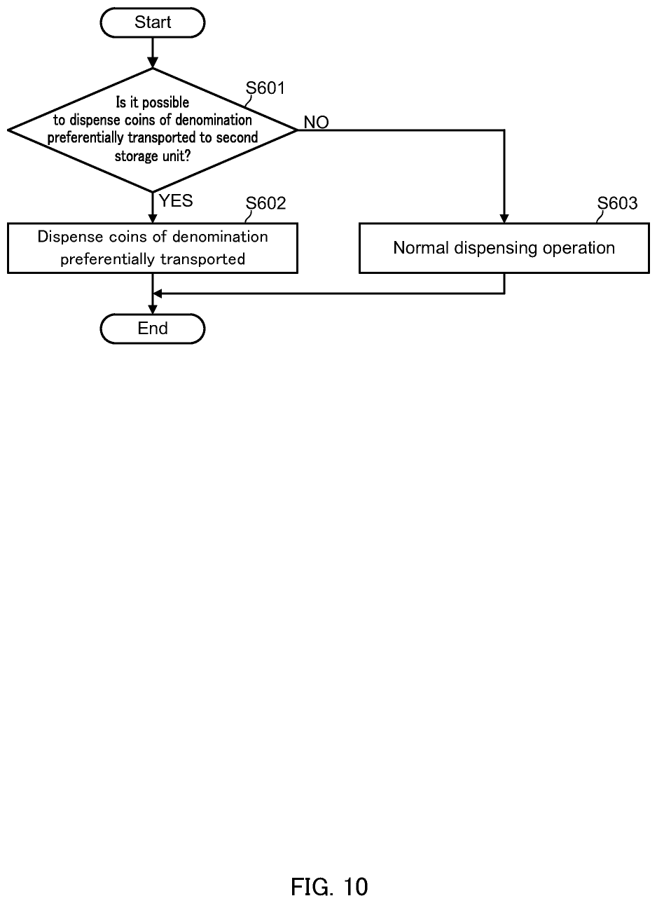

Next, the dispensing operation by the coin handling apparatus 1 according to Embodiment 4. FIG. 10 is a flowchart illustrating the dispensing operation performed by the coin handling apparatus according to Embodiment 4. Note that the present example is applied to a case where it is desirable that a coin of a predetermined denomination (the 1-cent coin in the present embodiment) be preferentially used as change in the operation of a store in which the coin handling apparatus 1 is installed.

Upon receiving a dispensing instruction, the control unit 18 determines whether the coin of the denomination preferentially transported to the second storage unit 7, that is, the 1-cent coin, can be dispensed (step S601). In the present example, a case where dispensing one 2-cent coin is requested will be described.

When it is determined that the coin of the denomination preferentially transported to the second storage unit 7 can be dispensed, that is, when there are two or more 1-cent coins in the second storage unit 7 (“YES” step S601), the control unit 18 dispenses the coins of the denomination preferentially transported (step S602), and the dispensing operation ends. In this example, two 1-cent coins are dispensed instead of one 2-cent coin.

When it is determined that the coins of the denomination preferentially transported to the second storage unit 7 cannot be dispensed, that is, when the number of 1-cent coins in the second storage unit 7 is one or less (“NO” in step S601), the control unit 18 performs the normal dispensing operation (step S603), and the dispensing operation ends.

Incidentally, in the operation in which the 1-cent coin is preferentially used as change, when coins of the denomination already preferentially transported to the second storage unit 7 have reached the same amount of money as a coin of an immediately higher denomination than the denomination of the already preferentially transported coins, and, even when a coin of the denomination deposited in the deposit process is of the denomination to be preferentially transported, the control unit 18 may transport and store the deposited coins to and in the first storage unit 5 instead of the second storage unit 7. Specifically, in the case where two 1-cent coins are stored in the second storage unit 7, a 1-cent coin deposited thereafter is stored not in the second storage unit 7 but in the first storage unit 5.

As described above, according to the control method for the coin handling apparatus and the coin handling apparatus of Embodiment 4, when the condition that a coin is of a denomination not used as change is satisfied, such a coin is preferentially transported to the second storage unit regardless of the dispense fund pattern setting. Accordingly, when a coin is set as the coin of the denomination not used as change, it is possible to efficiently collect or use such a coin, so as to improve the flexibility of the operation of the coin handling apparatus.

### Embodiment 5

Next, Embodiment 5 of the control method for the coin handling apparatus and the coin handling apparatus of the present disclosure will be described. In Embodiment 5 described below, the same reference numerals are given to the same components as those in Embodiment 1, and the description thereof will be omitted. Embodiment 5 is different from the other embodiments in the dispensing preparatory operation and the dispensing operation performed in the case where preparation of the change fund is not completed, among the basic operations of the coin handling apparatus.

Embodiment 5 will be described with reference to the accompanying drawings. Since the basic configuration of the coin handling apparatus and the functional configuration of the coin handling apparatus are the same as those of Embodiment 5, the description thereof will be omitted.

### Dispensing Preparatory Operation

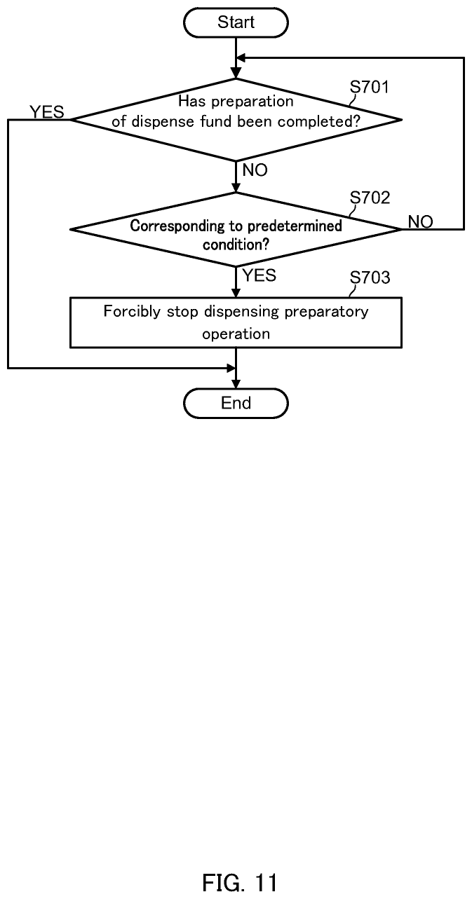

The dispensing preparatory operation by the coin handling apparatus 1 according to Embodiment 5 will be described. FIG. 11 is a flowchart illustrating the dispensing preparatory operation performed by the coin handling apparatus according to Embodiment 5.

After the coins discharged from the second storage unit 7 by the dispensing operation are dispensed through the outlet 16, the control unit 18 starts the dispensing preparatory operation. Specifically, the control unit 18 prepares a dispense fund in the second storage unit 7.

After starting the dispensing preparatory operation, the control unit 18 determines whether the preparation of the dispense fund has been completed (step S701). In a preparation method for preparing the dispense fund, in a case where the coins already stored in the second storage unit 7 makes the change fund complete, the control unit 18 may determine at this time that the preparation has been completed. Alternatively, after coins for making up for the coins dispensed from the second storage unit 7 by the dispensing operation are all transported and stored from the first storage unit 5 to the second storage unit 7, the control unit 18 may determine that the preparation has been completed.

When it is determined that preparation for the dispense fund has been completed (“YES” in step S701), the dispensing preparatory operation ends.

When preparation for the dispense fund has not been completed, that is, when the coins already stored in the second storage unit 7 do not make the dispense fund complete, and when not all coins for making up for the dispensed coins have been obtained from the first storage unit 5, that is, when the dispense fund of a predetermined combination has not been stored in the second storage unit 7 (“NO” in step S701), the control unit 18 checks whether the predetermined condition is satisfied (step S702).

The predetermined condition may include the following two cases. The first condition is a case where a predetermined time for the dispensing preparatory operation as set by the control unit 18 in advance has elapsed, and the second condition is a case where the next deposit acceptance command arrives. Determination may also be made by any one of the conditions.

When it is determined that the predetermined condition is not satisfied (“NO” in step S702), the control unit 18 continues preparation of the dispense fund.

When it is determined that the predetermined condition is satisfied (“YES” in step S702), the control unit 18 forcibly stops the dispensing preparatory operation (step S703), and the dispensing preparatory operation ends. That is, the process ends in a state in which the dispense fund is not prepared in the second storage unit 7.

### Dispensing Operation

Next, a dispensing operation by the coin handling apparatus 1 according to Embodiment 5 will be described.

Upon receiving a dispensing instruction, the control unit 18 starts the dispensing operation. In the dispensing preparatory operation, the process ends in the state in which the dispense fund cannot be prepared in the second storage unit 7. Thus, the control unit 18 performs one of the following three dispensing operations.

### Dispensing Operation 1

In a case where the requested amount of money in the dispensing instruction is greater than the amount of the dispense fund stored in the second storage unit 7, the entire change fund stored in the second storage unit 7 is first transported directly to the outlet 16 and not via the recognition unit 15. Thereafter, the coins of the denominations stored in the first storage unit 5 are transported to the recognition unit 15. Then, the required denomination and number of coins necessary for the requested amount of money are selected and transported to the outlet 16.

### Dispensing Operation 2

In a case where the requested amount of money in the dispensing instruction is greater than the amount of the dispense fund stored in the second storage unit 7, coins of the denominations stored in the second storage unit 7 and coins of the denominations stored in the first storage unit 5 are discharged together to the feeding unit 8, and the necessary denominations and numbers of coins are selected by the recognition unit 15, and are transported to the outlet 16.

### Dispensing Operation 3

When the requested amount of money in the dispensing instruction is greater than the amount of the dispense fund stored in the second storage unit 7, the coins of the denominations stored in the first storage unit 5 are transported from the feeding unit 8 to the recognition unit 15, the required denominations and numbers of coins necessary for the requested amount of money in the dispensing instruction are selected and transported to the second storage unit 7. Thereafter, all the coins stored in the second storage unit 7 are transported directly to the outlet 16 and not via the recognition unit 15.

When the requested amount of money in the dispensing instruction is greater than the amount of the dispense fund stored in the second storage unit 7, the control unit 18 performs any one of the dispensing operations 1 to 3, and the dispensing operation ends. Incidentally, when the requested amount of money in the dispensing instruction is less than the amount of the dispense fund stored in the second storage unit 7, the coins stored in the second storage unit 7 are discharged to the feeding unit 8, recognized by the recognition unit 15 for selection of the coins required for dispensing, and transported to the outlet 16 in a normal manner.

As described above, according to the control method for the coin handling apparatus and the coin handling apparatus of

Embodiment 5, it is possible to dispense the required amount of money without extending the time for preparing the dispense fund.

### Variation 1

In order to keep the target ratio of coins of a plurality of denominations stored in the first storage unit 5, the control unit 18 may monitor the ratio of denominations of coins stored in the first storage unit 5. When a term of the ratio of the denomination A is lower than a setting value by X % and a term of the ratio of the denomination B having a small face value exceeds a setting value by Y %, a control may be performed in which A is substituted with B. Any setting values X and Y can be set. It is thus possible to eliminate an extra time for the dispensing preparatory operation which is caused by an excessively reduced number of coins of a particular denomination which are likely to be left undischarged.

### Variation 2

The control unit 18 may calculate the dispensing ratio from data collected in past D weeks, and may perform control so as to automatically update the target ratio set for the first storage unit 5, that is, the optimal numbers of coins (threshold values) for the respective denominations. The setting value D can be set to an arbitrary value.

### Variation 3

The control unit 18 may perform control so as to request replenishment when a term of the ratio of a particular denomination stored in the first storage unit 5 falls below the setting value by E %. The setting value E can be set to an arbitrary value. As a default, values calculated from an experiment are set as the setting values E for the respective denominations such that the dispensing preparatory operation ends within a predetermined time.

### Variation 4

The above-described embodiment has been described in relation to the example in which the coins of the rare denominations and the denomination that is not used as change in the store are transported to the second storage unit 7. However, these coins may be transported to the first storage unit 5 depending on conditions. For example, in addition to the coins of the above-described denominations, a coin of a rare denomination such as a commemorative coin, a denomination that is not used as change in the store, such as a high-denomination coin set by the store, a particular denomination of coin having the same face value as a banknote, and the like are set as coins for deposit only (hereinafter, referred to as “deposit-only coins”). A transport destination in a case where a deposit-only coin is deposited is changed depending on the conditions. For example, depending on the deposit frequency of the deposit-only coin, the deposit-only coin is transported to the first storage unit 5 when the deposit frequency is equal to or greater than a predetermined value, and the deposit-only coin is transported to the second storage unit 7 when the deposit frequency is less than the predetermined value. Additionally or alternatively, for example, when scheduled collection time is close, the deposit-only coin is transported to the second storage unit 7, and when the scheduled collection time is not close, the deposit-only coin is transported to the first storage unit 5. Additionally or alternatively, for example, depending on the collection frequency, the deposit-only coin is transported to the second storage unit 7 when the collection frequency is high, and the deposit-only coin is transported to the first storage unit 5 when the collection frequency is low. Additionally or alternatively, for example, the deposit-only coin may be transported to the second storage unit 7 when the setting or the like permits the deposit-only coins to be dispensed. Depending on the number of deposit-only coins stored, mode switching may be performed such that the deposit-only coin is transported to the first storage unit 5 when the number of deposit-only coins exceeds a predetermined number. In the case of the mode switching, the deposit-only coins already stored in the second storage unit 7 may be moved to the first storage unit 5. Thus, the deposit-only coins are stored in the second storage unit 7 having a smaller capacity, so that collection/discharge of the deposit-only coins is facilitated, while under the conditions that the deposit-only coins cannot be collected or discharged, the deposit-only coins are stored in the first storage unit 5 having a larger capacity, so that stops of the apparatus caused when the storage units are full can be reduced.

The control method for the coin handling apparatus and the coin handling apparatus according to the present disclosure are not limited to the embodiments described in detail so far, and various modifications made without departing from the gist thereof are also included in the control method for the coin handling apparatus and the coin handling apparatus according to the present disclosure.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A method for controlling a coin handling apparatus, comprising:
performing a preparatory operation including:
recognizing by a recognition unit a denomination of a coin fed from a first storage unit that stores one or more coins, and
storing, in a second storage unit, a certain number of coins for each denomination of a first combination from among the one or more coins based on the denomination recognized; and
dispensing at least a part of the certain number of coins stored in the second storage unit to an outlet in response to a dispensing instruction, wherein
when a predetermined condition is satisfied, a certain number of coins for each denomination of a combination different from the first combination are stored in the second storage unit.

2. The method according to claim 1, wherein
the predetermined condition is a condition relating to a time for the preparatory operation for storing the certain number of coins from the first storage unit to the second storage unit.

3. The method according to claim 2, wherein
the predetermined condition is a case where the time for the preparatory operation is equal to or longer than a predetermined time.

4. The method according to claim 2, wherein
the predetermined condition is a case where the preparatory operation is not completed when a next deposit acceptance command arrives.

5. The method according to claim 1, wherein
a coin of a denomination which is inadequate in number for the first combination is substitutable with a coin of a denomination whose face value is smaller than that of the denomination of the coin which is inadequate in number for the first combination.

6. The method according to claim 1, wherein:
the predetermined condition is a condition of a ratio of coins for each denomination stored in the first storage unit, and
when a term of the ratio of coins of a first denomination is equal to or greater than a predetermined value, a certain number of the coins of the first denomination which make a same amount of money as a face value of a second denomination whose face value is greater than that of the first denomination are stored instead of a coin of the second denomination in the second storage unit.

7. The method according to claim 1, wherein:
the predetermined condition is a condition of a number of coins for each denomination stored in the first storage unit, and
when the number of coins of a first denomination is equal to or greater than a predetermined value, a certain number of the coins of the first denomination which make a same amount of money as a face value of a second denomination whose face value is greater than that of the first denomination are stored instead of a coin of the second denomination in the second storage unit.

8. The method according to claim 6, wherein
the certain number of coins of the first denomination which make the same amount of money as the face value of the second denomination are dispensed instead of the coin of the second denomination in response to the dispensing instruction.

9. The method according to claim 1, further comprising:
storing a deposited coin in the first storage unit, wherein
the predetermined condition is a condition relating to a denomination of the deposited coin, and
when the predetermined condition is satisfied, a coin of a corresponding denomination from among a plurality of the deposited coins is stored in the second storage unit.

10. The method according to claim 9, wherein
the predetermined condition is that a coin of a denomination preset by a user is deposited.

11. The method according to claim 9, wherein
the predetermined condition is that a coin of a rare denomination is deposited.

12. The method according to claim 9, wherein
the predetermined condition is that a coin of a denomination, coins of which denomination are stored in the first storage unit, is deposited in the first storage unit, the coins are greater in number than an initial setting for a number of coins.

13. The method according to claim 10, wherein
the coin of the preset denomination is a coin of a denomination which is not used as change.

14. A coin handling apparatus, comprising:
a first storage unit that stores a coin;
a second storage unit that stores a coin to be dispensed;
a transport unit that transports the coin along a transport path;
a recognition unit disposed on the transport path and configured to recognize a denomination of the coin; and
a control unit that controls the transport unit based on a result of recognition by the recognition unit such that a certain number of coins for each denomination of a first combination are stored in the second storage unit, the certain number of coins being from among a plurality of the coins fed from the first storage unit, wherein
the control unit is capable of storing, in the second storage unit, a certain number of coins for each denomination of a combination different from the first combination when a predetermined condition is satisfied.

15. The coin handling apparatus according to claim 14, wherein:
the predetermined condition is a case where a time for a preparatory operation in which the coin to be dispensed is stored in the second storage unit is equal to or greater than a predetermined value, and
when the predetermined condition is satisfied, a coin of a denomination whose face value is smaller than a face value of a coin of a denomination which is inadequate in number for the first combination is storable in the second storage unit instead of the coin which is inadequate in number for the first combination.
